(19) United States
(12) Patent Application Publication
(10) Pub. No.: US 2012/0170701 A1
(43) Pub. Date: Jul. 5, 2012

(54) PROTON ENGINE

(76) Inventor: Owen Venmore Ross, Venice, CA (US)

(21) Appl. No.: 13/336,976

(22) Filed: Dec. 23, 2011

Related U.S. Application Data
(60) Provisional application No. 61/460,364, filed on Dec. 30, 2010.

(51) Int. Cl. G21G 1/10

(52) U.S. Cl. 376/195

(57) ABSTRACT

A power generation device that converts matter into energy. A solenoid is rotated circumferentially at high speed clockwise or counter-clockwise. A coiled semi-conductor tube of similar size, which contains charged particles in gas or plasma form is rotated at high speed in the opposite direction. The hollow coil is wrapped in a conducting coil that creates a magnetic field inside it, holding the particles in place as an RF coil injects a resonant frequency to align the spins of the particles. The particles are driven at a high rate of speed into the solenoid's Magnetic field. The resulting energy output is collected.

### CROSS-REFERENCES TO RELATED APPLICATIONS

This application claims priority from U.S. application No. 61/460,364, filed Dec. 30, 2010 and which is incorporated by reference in its entirety.

### BACKGROUND

The present invention relates to power generation. The equation E=mc² implies that a large amount of energy is locked up inside fermionic matter. Traditional combustion releases energy by breaking down molecular chemical bonds, which results in inconvenient emissions and leaves the large energy of individual atomic nuclei untapped.

Free neutrons exist only a short time before they decay (approximately 15 minutes). Neutrons are composed of three quarks, one ‘up quark’ and two ‘down quarks’. In neutron beta decay one of the two ‘down quarks’ switches to an ‘up quark’, emitting an electron and a neutrino. The remaining proton is left with two ‘up quarks’ and one ‘down quark’. The present invention aims at the remaining ‘down quark’ or either one of the remaining ‘up quarks’ to trigger the decay of the proton, thereby converting it into energy. Mass is a force, and by countering nucleon constituents in the right place, with the right amount of countervailing force, mass can be destroyed to release energy.

### BRIEF SUMMARY OF THE INVENTION

The main object of the present invention is to unlock the vast stores of energy inside of nucleons.

In one embodiment, ionized protium, in gas or plasma form, is employed. Hydrogen has several isotopes, the most common of which is ¹H, protium, consisting of one proton and one electron. With the electrons stripped away, what remains are individual positively charged protons.

One embodiment of the present invention consists of two arms attached to a central pivot and which rotate circumferentially in opposite directions. The arms are designed such that they can pass through each other without hindrance at variable rates of speed (one arm passing inside the other, for example).

Firmly attached to the end of each arm is a coil, both of approximately similar size. They are constructed such that the coils, just as the arms that hold them, may pass through each other without hindrance at variable rates of speed.

One of the coils (Coil A) is a solenoid, an electromagnet. When current runs through the coil a magnetic field of proportional magnitude runs down the center of the coil. This magnetic field can be switched on and off at will.

The other coil (Coil B) is sized proportionally to Coil A such that it can pass through inside Coil A and thus into or across the magnetic field of Coil A when that field is turned on.

In one embodiment of the invention, Coil B is a hollow tube constructed of semi-conductor material with a semi-conductor layer on the inside surface of the tube which can convert photons into electricity or collect electrons directly.

In one embodiment, Coil B is additionally wrapped with a nonmagnetic conductor which will minimally interact with the magnetic field of Coil A, but also form a magnetic field inside and down the center of Coil B when conducting.

In one embodiment, Coil B is wrapped with an RF coil. Magnetic resonance is a property that relates to the spins of atomic nuclei. When Coil B is filled with protium and the magnetic field from the RF coil is turned on, the spins of the protons inside the tube line up in accordance with the magnetic field, pointing magnetically either north or south, thereby manifesting two different spin states, a higher energy spin state and a lower energy spin state. By injecting an RF frequency of the proper strength (a function of the strength of Coil B's magnetic field), the lower energy spin states can be converted to higher energy spin states, such that all the protons inside Coil B will be oriented in the same direction within the magnetic field.

When the RF frequency is turned off, the protons that were ‘upped’ to the higher energy spin state will ‘relax’ to the lower energy spin state by emitting a photon: at this moment these relaxing protons can be slammed at a high rate of speed into the magnetic field of Coil A, triggering the destruction of some proportion of these protons inside Coil B, converting them into energy, which is then collected from Coil B.

Alternatively the magnetic field inside Coil B can be used to hold the protons in place at an optimal angle based on the size of the machine and other variables, as the protons collide into the magnetic field of Coil A. The protons can be slammed into the opposing field of Coil A or ‘ground’ through the opposing fields.

A timing device may coordinate the speed of the arm rotations, turns the magnetic fields of Coil A and Coil B on and off in proper sequence and synchronizes the injection of any RF signal.

### BRIEF DESCRIPTION OF THE DRAWINGS

FIG. 1 is a top sectional view of the mechanism inside an encasement;

FIGS. 2-3 illustrate each arm of the mechanism and its attached coil; and

FIGS. 4a and 4b illustrate two views of Coil B, a side-view and a cross-sectional view.

### DETAILED DESCRIPTION OF THE PREFERRED EMBODIMENTS

The present disclosure relates generally to a power generation system which unlocks the energy of particles by driving them at a high rate of speed into a magnetic field. The required high rate of speed will vary depending. on the size of machine, amount of energy to be produced, and other variables. In any event, it should be a speed sufficient to destroy the particles within the environment of the particular device. The precise speed required for a given device can be fine-tuned by one skilled in the art.

According to the Lorentz force law, a particle carrying 1 coulomb of charge and passing through a magnetic field of 1 tesla at a speed of 1 meter per second, experiences a force of 1 newton. By increasing the speed at which a particle passes through a magnetic field, the force the particle experiences will increase accordingly.

By holding the particles in place with an additional magnetic field and adjusting the angle at which they strike the primary magnetic field, the force imposed by the primary field can be concentrated to specific loci to destroy mass.

In one embodiment, the stimulated emission of photons by the particles provides a target.

In one embodiment, the collision with the magnetic field replicates matter/anti-matter annihilation.

In one embodiment, the force of the magnetic field acting on positively charged particles overcomes the mutual electrostatic repulsion of the Coulomb barrier, fusing nuclei and releasing energy.

The present disclosure relates generally to power generation by the destruction of mass with magnetic force. Mass is inherent in the constituents of nucleons and can be countered by an equivalent amount of contrary force delivered by a magnetic field targeted to nucleons, which can be held in place by one or more secondary magnetic fields, so as to control the locality of contact. The targeted nucleons might also be held in place by other means, such as by the density of the nucleon matter or by other properties of the nucleon matter, or by being held in a ‘trap’ or a channel when collided with the primary and other fields. Nucleons are collided into magnetic force in order to impose enough force upon each nucleon individually to counter the force of its mass, and thereby destroy it and release its energy as per the equation E=mc².

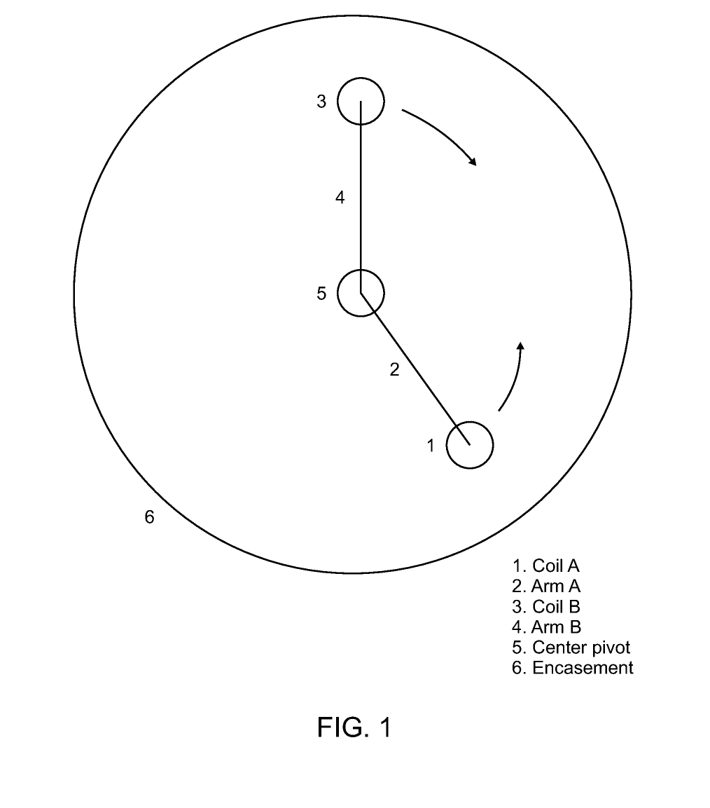

FIG. 1 illustrates a non-limiting example of one embodiment of the mechanism as viewed from above. A center pivot 5 has attached to it two arms 2 and 4 and functions such that it propels the rotation of Arm A 2 circumferentially at high speed counterclockwise and Arm B 4 circumferentially at high speed clockwise. In one embodiment, Arm B 4 is designed such that it may fit inside Arm A 2 and thus pass through it with no encumbrance at variable speed. Attached at the end of Arm A 2 is Coil A 1 and attached at the end of Arm B 4 is Coil B 3. Coil B 3 is shaped and sized such that it may fit inside Coil A 1 and thus pass through Coil A 1 with no encumbrance just as Arm B 4 passes through Arm A 2. In one embodiment, the center pivot 5 is a magnetic bearing that eliminates friction and allows the arms to rotate circumferentially 360° in opposite directions at high speed inside of the encasement 6.

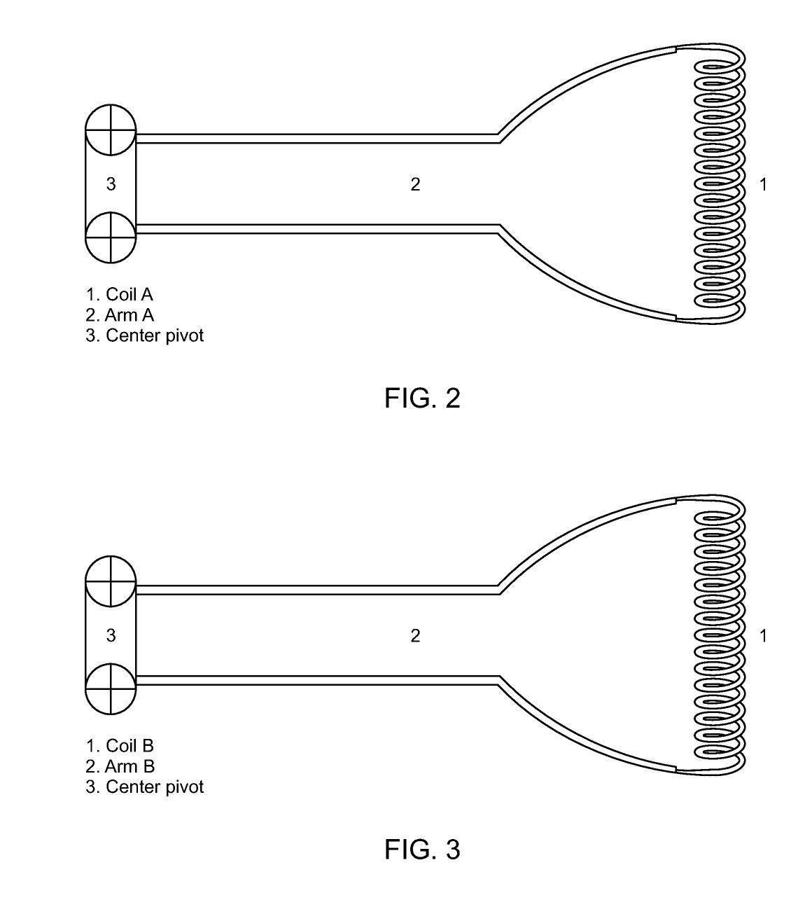

FIG. 2 illustrates Coil A 1 attached to Arm A 2 and joined to the center pivot 3. Coil A 1 is a solenoid and when current is run through the coil a magnetic field forms running down the center of the coil.

FIG. 3 illustrates Coil B 1 attached to Arm B 2 and joined to the center pivot 3. In one embodiment. Coil B 1 is a hollow tube constructed of semi-conductor material, the inner surface of which is photo-electric, such that it can convert photons created inside the tube into electricity which will conduct through Coil B 1 for utilization.

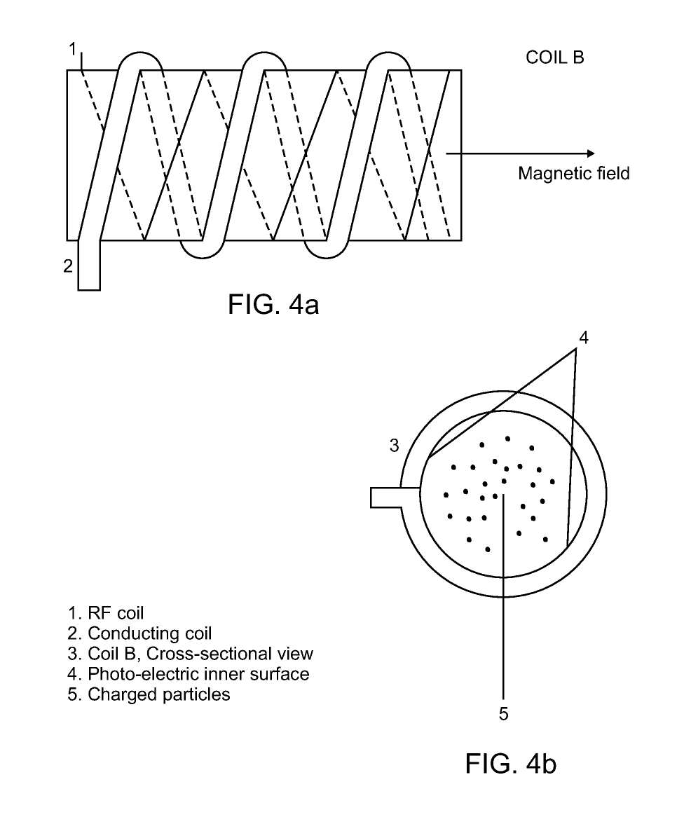

FIG. 4 shows two close-up views of Coil B, a side-view and a cross-sectional view 3. The side-view of Coil B illustrates an embodiment in which Coil B is a hollow tube wrapped with an RF coil 1 and a Conducting coil 2. When current is run through the Conducting coil 2 a magnetic field forms down the center of Coil B. In one embodiment, charged particles 5 fill the hollow tube, surrounded by photo-electric semi-conductor material along the inner surface 4 of Coil B. In one embodiment, the charged particles 5 are protons in the form of protium gas or plasma. When the magnetic field inside Coil B is turned on by running current through the Conducting coil 2, the spins of all the protons inside the tube line up in either a higher energy spin state or a lower energy spin state. By injecting an RF signal through the RF coil 1 of appropriate strength, the lower energy spin states can be boosted to higher energy spin states. When the RF signal is removed the boosted protons will relax to their lower energy spin state by emitting photons. In one embodiment, photon emission provides a loci and a time target for the magnetic field of Coil A to slam into the protons inside of Coil B, and the magnetic field inside Coil B either remains on or is turned off to increase the force on the protons 5.

In one embodiment, energy output is in the form of electrons which are conducted through the semi-conducting or conducting material on the inner surface of Coil B towards utilization.

In one embodiment, the energy is collected by a photo-electric inner surface 4 of Coil B and conducted through the semi-conductor material of Coil B, through Arm B towards utilization, or by using the encasement itself as an electrode, whether through direct contact with Coil B or across the medium separating Coil B from the encasement. Other embodiments may include other methods of power conversion, such as heat being conducted through Coil B to the surrounding medium inside the encasement, or heat being conducted through direct contact between Coil B and the encasement.

Other embodiments of the power generating system may include a design whereby two or more wheels of arms bring matching coils together in gear-like fashion. Another embodiment may design a hollow tube component to pass through the solenoid coil across the length of the magnetic field or around the length of a magnetic field created within a ‘looped’ circular solenoid. Other embodiments may only move one arm with one hollow tube while creating the magnetic collision field directly from the encasement. In one embodiment multiple arms holding hollow tubes are spun and collided into a single collision field and in another embodiment one hollow tube is collided into multiple collision fields. In one embodiment the hollow coiled tube is constructed so that it may spin on its axis at variable speed while being rotated circumferentially. In one embodiment two plates are spun in opposite directions, one plate with the mass particles, the other with one or more magnetic fields to destroy the mass particles as the two spinning plates are ‘sandwiched’ together. In one embodiment nucleons are shot from a gun into one or more magnetic fields that are either stationary or in motion. In one embodiment two or more concentric cylinders are spun in opposite directions within each other to collide nucleons with magnetic fields.

In one embodiment of the present disclosure, the power generation device is connected to an electrolytic cell which feeds the hollow tube with particles. In one embodiment of the present invention, the electrolytic cell performs the electrolysis of water to feed the hollow tube with hydrogen.

It should of course be understood, that the description and the drawings herein are merely illustrative, and it will be apparent that various modifications, combinations and changes can be made of the structures disclosed without departing from the spirit of the invention and from the scope of the appended claims.

1. A power generation device for converting matter into energy by driving particles into a magnetic field at a high rate of speed, comprising:
a solenoid attached to a first arm that spins circumferentially around a central pivot at a high rate of speed in one of a clockwise or counter-clockwise direction;
a coil-shaped hollow tube attached to a second arm that spins circumferentially around a central pivot at a high rate of speed in a direction opposite to the rotation of the first arm, and which can be wrapped in a conducting coil and an RF coil and contains particles;
an energy collection and conversion system for harvesting the energy unlocked from the particles inside the hollow tube.

2. The power generation device of claim 1 in which protons or other particles in gas or plasma or liquid or solid form are injected into the hollow tube and held in place by a magnetic field generated by a conducting coil wrapped along the length of the tube.

3. The power generation device of claim 2 in which the spin states of the protons or other particles within the magnetic field inside the hollow tube are controlled by RF signals provided by an RF coil wrapped along the length of the tube, so as to maximize the effectiveness of impact with the collision field.

4. The power generation device of claim 2 in which the magnetic field within the hollow tube is turned on and off with respect to maximizing the force exerted on the particles when collided with the magnetic field of the spinning solenoid.

5. The power generation device of claim 1 wherein the device further comprises a switch for turning the magnetic field of the spinning solenoid on and off with respect to targeting the particles in the hollow tube precisely and maximizing the force exerted upon them.

6. The power generation device of claim 1 in which the inner surface-area of the hollow coiled tube is a photo-electric semiconductor material that can convert photons into electrical current.

7. The power generation device of claim 1 in which the hollow coiled tube serves as a semi-conducting conductor for the electrical current generated from inside the tube.

8. The power generation device of claim 1 in which the hollow coiled tube serves as a heat conductor for the energy released inside the tube.

9. The power generation device of claim 1 in which the force exerted by the magnetic field colliding at a high rate of speed with the particles in the hollow coiled tube, causes those particles to overcome the Coulomb barrier between them and fuse, releasing quantities of energy.

10. The power generation device of claim 1 enclosed in an encasement which can also be utilized as an electrode in the energy collection process.

11. The power generation device of claim 1 in which the encasement can also enclose a medium, such as gas or liquid, that can be utilized as a working fluid or for heat convection or conduction or electrical conduction.

12. The power generation device of claim 1 in which both spinning arms are attached to a central pivot constructed from a magnetic bearing so as to minimize friction.

13. The power generation device of claim 1 in which a timing control system coordinates the speed of the arms, turns the magnetic fields of a Coil A and a Coil B on and off in proper sequence, can reverse the currents and synchronize the injection of the RF signal, all in accordance with the energy generation demands placed upon the mechanism.

14. The power generation device of claim 1 in which an electrolytic cell feeds particles into the hollow tube.

15. A method of generating energy comprising the steps of:
holding mass particles in place;
moving mass particles held in place;
colliding mass particles held in place with one or more magnetic fields;
imposing magnetic force upon mass particles held in place;
destroying mass particles with magnetic force to create energy; and
harvesting the energy that's unlocked.

16. The power generation method of claim 15 in which the primary magnetic field is contained within a looped solenoid and mass particles are spun through the solenoid in circular fashion.

17. The power generation method of claim 15 in which the mass particles are held in place within one plate, while one or more colliding fields are contained within a second plate, designed so both plates can be brought together as each spins in opposite directions, or else be struck together in a piston motion.

18. The power generation method of claim 15 in which the method comprises providing a power generation device at nano scale.

19. The power generation method of claim 15 in which the method comprises providing a power generation device at industrial scale.

20. The power generation method of claim 15 in which a solenoid is rotated circumferentially clockwise or counter-clockwise while a coiled hollow tube containing mass particles is rotated in the opposite direction to collie the mass particles with the magnetic field of the solenoid.

21. The power generation method of claim 15 in which the spin orientations of nucleons are held in place by the manner in which they are shot from a propulsion device to strike one or more stationary or moving magnetic fields so they strike the field at the angle of their orientation that produces energy yield.

22. The power generation method of claim 15 in which two or more concentric cylinders are spun in opposite directions within each other to collide nucleons with magnetic fields.

23. A method of generating energy utilizing a device as defined in claim 1, wherein method comprises:
employing the device as defined in claim 1 to:
hold mass particles in place;
move mass particles held in place;
collide mass particles held in place with one or more magnetic fields;
impose magnetic force upon mass particles held in place;
break apart mass particles with magnetic force to create energy; and
harvest energy that is generated.

24. A power generation device for converting matter into energy by driving particles into a magnetic field at a high rate of speed.

25. The power generation device of claim 24 in which mass particles are shot from a propulsion device into one or more magnetic fields that are stationary or in motion.

26. The power generation device of claim 24 in which two or more concentric cylinders are spun in opposite directions within each other to collide nucleons with magnetic fields.

27. The power generation device of claim 24 in which the primary magnetic field is contained within a looped solenoid and mass particles are spun through the solenoid in circular fashion.

28. The power generation device of claim 24 in which the mass particles are held in place within one plate, while one or more colliding fields are contained within a second plate, designed so both plates can be brought together as each spins in opposite directions, or else be struck together in a piston motion.
